(19) United States
(12) Patent Application Publication
(10) Pub. No.: US 2006/0085540 A1
(43) Pub. Date: Apr. 20, 2006

(54) System and method for the use of redundant network interface cards

(75) Inventors: Jeffrey Mayerson, Austin, TX (US); Onur Celebioglu, Austin, TX (US); Baris Guler, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/967,714

(22) Filed: Oct. 18, 2004

(51) Int. Cl. G06F 15/173

(52) U.S. Cl. 709/224

(57) ABSTRACT

A system and method is disclosed for providing a redundant network interface card in an information handling system. Each of the network interface cards of the computer system is coupled to an external switch. When a failure is identified in one of the network interface cards, a signal is sent to the external switch, which causes the bus from an alternate network interface card to be coupled to the computer network.

### TECHNICAL FIELD

The present disclosure relates generally to information handling systems, and, more particularly, to a system and method for the use of redundant network interface cards.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include a network interface card for coupling the system to a network. As an example, a server computer may be coupled to the network switch of a network though a network interface card installed in the computer system. A server computer may include dual network interface cards. One of the two network interface cards will be active and will be coupled to and used as the link to the network. This network interface card is sometimes referred to as the primary network interface card. The other network interface card will be idle and will be used if the first network interface card fails. The idle network interface card is sometimes referred to as the secondary network interface card. If the primary network interface cards fails, the operating system and the software drivers of the server computer will attempt to communicate with the network though the secondary network interface card. The secondary network interface card, however, must be physically connected to the network, and the rerouting of the physical network connection from the primary network interface card to the secondary network interface card must be done manually.

### SUMMARY

In accordance with the present disclosure, a system and method is disclosed for providing a redundant network interface card in an information handling system. Each of the network interface cards of the computer system is coupled to an external switch. When a failure is identified in one of the network interface cards, a signal is sent to the external switch, which causes the bus from an alternate network interface card to be coupled to the computer network. The signal sent to the external switch may be transmitted from a USB port in the information handling system.

The system and method disclosed herein is technically advantageous because it provides a system and method for physically switching to an alternate network interface card that can be automated and does not involve physical access to the network interface cards and the manual switching from one network interface card on the part of a user or system administrator. As such, the system and method disclosed herein permits both the logical and physical migration from a first network interface card to a second network interface card on an automated basis and without the involvement of the user or system administrator.

The system and method described here also advantageous in that the system and method can be implemented with and through the standard USB port of an information handling system. The external switch can also be powered through the USB port. As such, little additional hardware is necessary to implement the solution described herein. The system and method described herein is also advantageous in that the system and method can be implemented without the necessity of additional hardware within the network switch of the computer network. The network switch can include only a single port of connection to an information handling system that employs multiple network interface cards and the system and method disclosed herein. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer network;

FIGS. 2A and 2B are views of the active and passive lines of a network interface card switch; and

FIG. 3 is a flow diagram of a method for monitoring the connectivity of the server computer and migrating the connection of the server computer from a first network interface card to an alternate network interface card.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output(I/O) devices, such as a keyboard, a mouse, and a video display. The information handling system may also include one or more buses operable to transmit communications between the various hardware components. An information handling system may include a network interface card for coupling the information handling system to a computer network.

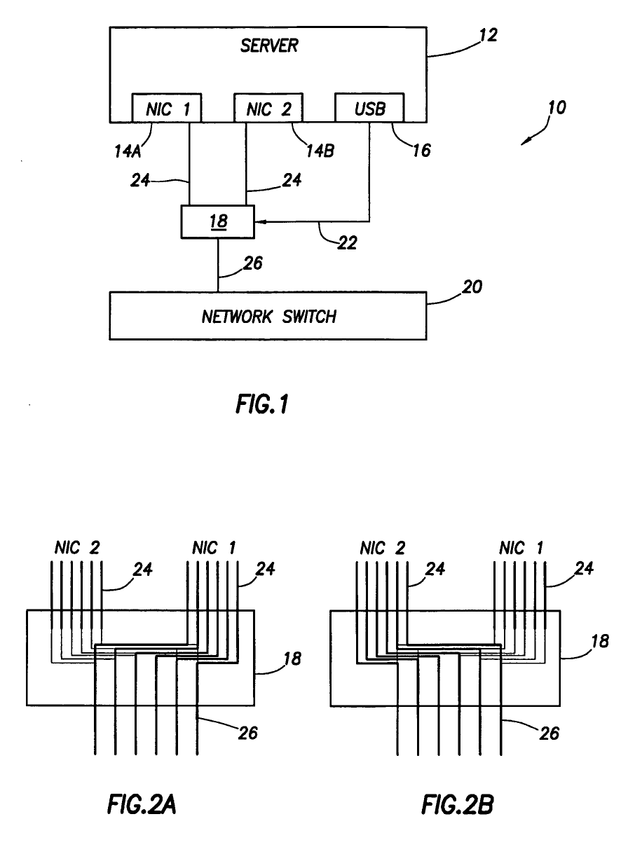

Shown in FIG. 1 is a diagram of a computer network, which is indicated generally at 10. Computer network 10 includes a server computer 12, which includes first and second network interface cards, which are identified as NIC 1 (identified as 14A) and NIC 2 (14B). Server computer 12 also includes a USB (Universal Serial Bus) port 16. Each of NIC 1 and NIC 2 are coupled via a bus 24 to an external NIC switch 18. Also coupled to NIC switch 18 is a communications and power link 22 from USB port 16. Also coupled to NIC switch 18 is a network switch 20, which provides a gateway through network connection 26 to the remainder of the computer network.

In operation, NIC switch 18 couples one of the two buses 24 to the remainder of the computer network. At any one time, one of the two network interface cards 14 is active and the other of the two network interface cards 14 is idle or passive. The bus 24 that is coupled to the active network interface card 14 is likewise active, and the bus 24 that is coupled to the idle or passive network interface card 14 is idle. When the connection is lost between the active network interface card and NIC switch 18, a signal on bus 22 from USB port 16 instructs the NIC switch to couple to switch its switching fabric so that the opposite bus, which was the idle or passive bus, is coupled to network switch 20 and the remainder of the computer network. As such, when the network connection between a network interface card and the NIC switch fails, a signal from USB port 16 instructs NIC switch 18 to couple the opposite network interface card and associated bus to network connection 26.

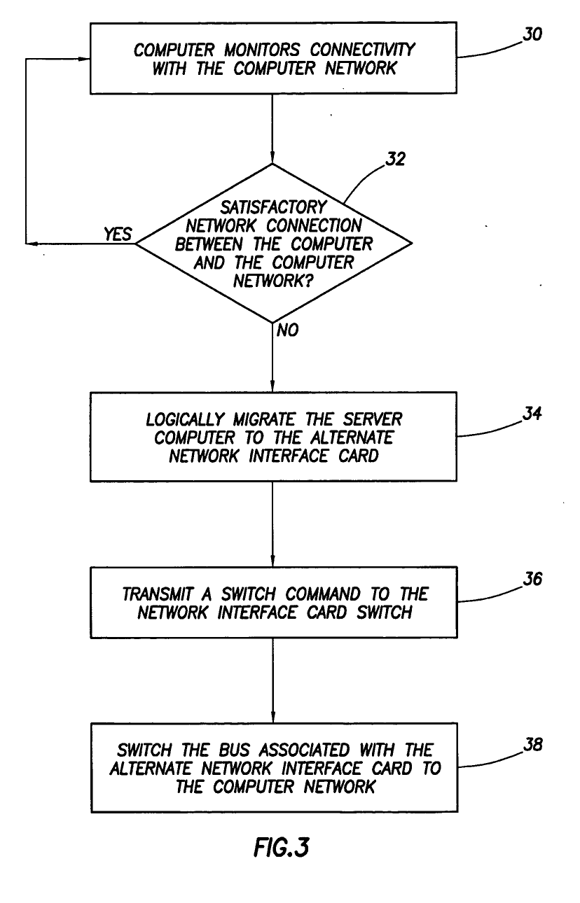

Shown in FIG. 2A is a view of NIC switch 18 which is coupled to a pair of buses 24 and a network connection 26. As indicated, one of the buses 24 provides signals from NIC 1 and the other bus 24 provides signals from NIC 2. In the example of FIGS. 2A and 2B, active communications lines are shown in bold, and passive communications lines are shaded. In the example of FIG. 2A, network connection 26 is coupled to the bus 24 associated with NIC 1. The lines of the bus 24 associated with NIC 1 are active, and the lines of the bus 24 associated with NIC 2 are passive. In FIG. 2B, following the receipt of a switch command transmitted from USB port 16, NIC switch 18 couples the lines of bus 24 associated with NIC 2 to network connection 26. In FIG. 2B, the lines of the bus 24 associated with NIC 2 are active, and the lines of bus 24 associated with NIC 1 are passive.

Shown in FIG. 3 is a flow diagram of a series of method steps for monitoring the connectivity of the server computer and migrating the connection of the server computer from a first network interface card to an alternate network interface card. At step 30, the server computer monitors the connectivity between the server computer and the computer network. The step of monitoring the connectivity of the network could be accomplished by a daemon or another software application that continuously identifies whether a satisfactory connection is established between the server computer and the computer network. At step 32, it is determined if a satisfactory network connection exists between the server computer and the computer network. If a satisfactory network connection exists, the state of network connectivity is continuously monitored at step 30. If it is determined that a satisfactory network connection does not exist, the server computer is logically coupled at step 34 to the alternate or passive network interface card. The operating system of the server computer logically disconnects the server computer from the formerly active network interface card and connects the server computer to the alternate network interface card. As a result of the logical connection of the server computer to the alternate network interface card, the server computer is reconfigured, at an operating system or software level, to communicate with the computer network through the alternate network interface card. At step 36, the server computer transmits a switch command through USB port 16 to NIC switch 18. The switch command causes NIC switch 18 at step 38 to switch to the bus 24 associated with the alternate network card, thereby coupling the server computer to the computer network through the alternate network card.

The system and method described herein is not limited in its use to any type or model of computer system or information handling system. Rather, the network interface card failure recovery method disclosed herein may be implemented in any information handling system that includes multiple network interface cards. In addition, because the step of switching between network interface cards is automated, and may be implemented in software, the step of initiating a switch between network interface cards may be initiated remotely. Moreover, the method for switching between network interface cards may be initiated by a user or a system administrator without reference to or in the absence of a failure in a network interface card.

It should be recognized that the system and method disclosed herein is not limited in its use to computer systems that includes only two network interface cards. Rather, the system and method described herein could be implemented in a system having greater than two network interface cards. In this circumstance, and in the event of network failure at a first network interface card, the signal from the USB port would instruct the NIC switch to couple the network connection to one of the other available network interface cards. Although the present disclosure has been described in detail, it should be understood that various changes, substitutions, and alterations can be made hereto without departing from the spirit and the scope of the invention as defined by the appended claims.

What is claimed is:

1. A method for switching between network interface cards in a computer system coupled to a computer network, comprising:
monitoring the status of the connection between the computer system and the computer network;
identifying an unsatisfactory connection between the computer system at a first network interface card and the computer network;
configuring operating system software of the computer system to transmit data to the computer network through a second network interface card; and
transmitting a switch command to an external switch that is coupled between the computer network and each of a bus coupled to the first network interface card and a bus coupled to the second network interface card, wherein the switch command causes the network switch to couple the bus coupled to the second network interface card to the computer network and to disconnect the bus coupled to the first network interface card to the computer network.

2. The method for switching between network interface cards in a computer system of claim 1, wherein the step of transmitting a switch command comprises the step of transmitting a switch command through the USB port of the computer system.

3. The method for switching between network interface cards in a computer system of claim 2, wherein the status of identifying an unsatisfactory connection between the computer system at a first network interface card and the computer network comprises the step of determining when the network connection between the computer system and the computer network is lost.

4. A computer system, comprising:
a primary network interface card;
a secondary network interface card;
a port;
a switch device coupled to each of the primary network interface card, the secondary network interface card, and the port;
wherein the switch device is also coupled to a computer network, and wherein the switch device is operable, in response to a signal received from the port, to disconnect the connection of the computer system to the computer network through the primary network interface card and to connect to the computer system to the computer network though the secondary network interface card.

5. The computer system of claim 4, wherein the port is a USB port.

6. The computer system of claim 4, wherein the switch device is external to the computer system.

7. The computer system of claim 4, wherein the switch device is powered through its coupled connection to the port.

8. The computer system of claim 4, wherein the switch device is coupled to the network switch of the computer network.

9. The computer system of claim 4, wherein the port is a USB port and wherein the USB port provides power to the switch device.

10. The computer system of claim 4,
wherein the switch device is external to the computer system; and
wherein the port is a USB port and wherein the USB port provides power to the switch device.

11. The computer system of claim 10, wherein the switch device is coupled to the network switch of the computer network.

12. A method for switch between a primary network interface card and an alternate network interface card in an information handling system, comprising:
providing a primary network interface card within the information handling system and coupled through a primary bus to a switch;
providing an alternate network interface card within the information handling system and coupled through an alternate bus to the switch;
providing a network connection between the switch and a network;
providing a communications signal link between the information handling system and the switch;
monitoring the status of the connection between the primary network interface card and the switch;
providing a switch command through the communications signal link to the switch if it is determined that the connection between the primary network interface and the switch is not satisfactory; and
at the switch, disconnecting the primary bus from the network connection and connecting the alternate bus to the network connection.

13. The method for switch between a primary network interface card and an alternate network interface card in an information handling system of claim 12, wherein the step of providing a communications signal link between the information handling system and the switch comprises the step of providing a communications signal link from a USB port of the information handling system.

14. The method for switch between a primary network interface card and an alternate network interface card in an information handling system of claim 13, wherein the step of providing a communications signal link between the information handling system and the switch comprises the step of providing power from the USB port to the switch.

15. The method for switch between a primary network interface card and an alternate network interface card in an information handling system of claim, wherein the switch is external to the information handling system.

16. An information handling system, comprising:
a primary network interface card;
a plurality of secondary network interface cards;
a port;
a switch device coupled to each of the primary network interface card, each of the secondary network interface cards, and the port;
wherein the switch device is also coupled to a computer network, and wherein the switch device is operable, in response to a signal received from the port, to disconnect the connection of the computer system to the computer network through the primary network interface card and to connect to the computer system to the computer network though one of the secondary network interface cards.

17. The information handling system of claim 16, wherein the port is a USB port.

18. The information handling system of claim 16, wherein the switch device is external to the computer system.

19. The information handling system of claim 16, wherein the port is a USB port and wherein the USB port provides power to the switch device.

20. The information handling system of claim 16, wherein the switch device is coupled to the network switch of the computer network.
